(19) United States
(12) Patent Application Publication
(10) Pub. No.: US 2005/0185544 A1
(43) Pub. Date: Aug. 25, 2005

(54) Reading device and method for checking the functionality of a reading device of this type

(75) Inventor: Dominik Berger, Graz (AT)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/062,319

(22) Filed: Feb. 18, 2005

(30) Foreign Application Priority Data
Feb. 20, 2004 (DE) 10 2004 008 472.6

(51) Int. Cl. G11B 7/00; G11B 7/085; G11B 20/10; H04N 5/76

(52) U.S. Cl. 369/47.22; 369/30.04; 369/30.1

(57) ABSTRACT

A reading device for detecting objects with identification marks is constructed so that it is possible to check the functionality of the reading device by fixedly assigning at least one supplementary identification mark. This supplementary identification mark can transmit a test signal that may contain at least information about the location, the configuration and the state of the reading device and the time of an interrogation. A method for checking the functionality of reading devices for reading identification marks, where at least one identification mark is fixedly assigned to the reading device, includes the step of determining the functionality by the fact that it is possible to communicate with the fixedly assigned identification mark. In the method for checking the functionality of a reading device for reading identification marks, at least information about the location, the configuration and the state of the reading device and the time of an interrogation may be read out from the fixedly assigned identification mark.

### CROSS REFERENCE TO RELATED APPLICATION

This application claims priority to German Patent Application Serial No. 10 2004 008 472.6, which was filed on Feb. 20, 2004, and is incorporated herein by reference in its entirety.

### TECHNICAL FIELD

The present invention relates to a reading device and to a method for checking the functionality of the reading device.

### BACKGROUND

Reading devices which detect and evaluate the type and number of articles at a predetermined location are increasingly being used, in particular, in the field of logistics. In this respect, WO 03/098533 A1 discloses the practice of fixedly installing reading devices at the locations to be monitored and providing the articles to be monitored with identification marks. The reading devices communicate with the identification marks via radio, for example, and thus obtain information about the type and number of articles which are situated at a location. In this case, the location information is stored in the reading device or in a central computer, with the result that it is possible to determine, at any time, the number of articles that are present at that location.

The disadvantage of this type of conventional arrangement is that it makes no difference whether the reading device is not reading an article because of a defect or because no article is actually present. For this reason, it is not possible to automatically detect a defect in the reading device. If the reading device is actually defective, it is additionally often complicated to replace a defective reading device on account of the requisite configuration.

### SUMMARY

In one aspect, the present invention is directed toward a reading device whose functionality can be checked using simple means and in another aspect, to a method for checking the functionality of the reading device.

At least one supplementary identification mark is assigned to the reading device according to one exemplary embodiment of the present invention. In the event of an interrogation request, this identification mark sends the information stored in it to the reading device. Reception of the data in the reading device serves as a functional check of the monitoring system. The received data may be on one individual identification mark or distributed over a plurality of identification marks. In this case, the data may contain information about the location, the configuration and the state of the reading device and the times of interrogations. Customary methods such as anticollision methods, frequency offset or separate identification numbers can be used to distinguish between data of this supplementary identification mark and data of the identification marks which are secured to the article to be monitored.

The invention makes it possible to easily test the functionality of reading devices which detect objects that have been provided with identification marks since at least one supplementary assigned identification mark can always be read. A further advantage of the invention is that defective reading devices can be replaced without reprogramming since information about the location, the configuration and the state of the reading device and the times of the interrogation can be contained in one or more of the supplementary identification marks—which are used for the purpose of testing—and can be transmitted. For the same reason, the invention makes it possible to use mobile reading devices since location information for the mobile reading device can be obtained from the location information (which is always available and can be read) of the supplementary identification marks.

Other features and advantages of the present invention will be apparent from the following detailed description when read in conjunction with the accompanying drawings.

### BRIEF DESCRIPTION OF THE DRAWING FIGURES

The foregoing and other features of the present invention will be more readily apparent from the following detailed description and drawings figures of illustrative embodiments of the invention in which:

FIG. 1 shows an embodiment of the reading device according to the invention.

FIG. 2 shows possible communication paths between individual components of the embodiment illustrated in FIG. 1.

FIG. 3 shows a mobile embodiment of the reading device according to the invention.

FIG. 4 shows an embodiment, in which the reading device according to the invention is used on a conveyor belt.

### DETAILED DESCRIPTION OF PREFERRED EMBODIMENTS

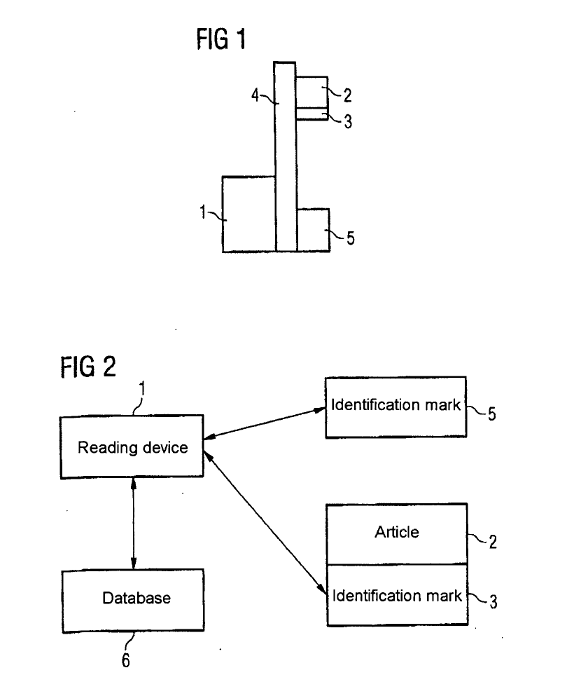

FIG. 1 illustrates a reading device 1, which is connected to a carrier unit 4, for example a rack. An article 2, to which an identification mark 3 has been attached, is furthermore situated on the carrier unit 4. In order to simplify the illustration, only one article 2 is illustrated in FIG. 1. However, it can easily be understood that, in most applications, a plurality of articles 2 are simultaneously provided in the vicinity of the reading device 1. This is the case, for example, whenever the article 2 is a sales article in a display rack. In this case, each article 2 has an identification mark 3. The article 2 may also be a packaging unit for a plurality of component articles. A plurality of reading devices 1 may be installed at different locations in a sales area or a warehouse, each connected to a carrier unit 4 or rack.

The identification mark 3 that is intended to be used in the illustrated exemplary embodiment is an integrated circuit that can be interrogated by radio and has an antenna (Radio Frequency Identification Tag, RFID). A supplementary identification mark 5 is attached to the carrier 4 in the vicinity of the article 2 to be monitored in order to check the functionality of the reading device 1.

FIG. 2 illustrates the functioning of the invention. In order to monitor the article 2, the reading device 1 sends out an interrogation request to identification marks 3 which can be addressed. In this case, the identification mark 3 is fixedly connected to the article 2 and is used to identify the latter. The interrogation request causes the identification mark 3 that is attached to the article 2 to send out the stored data. This data is then received by the reading device 1 and forwarded to a database 6. In addition to communicating with the identification mark 3 that is secured to the article 2, the reading device 1 also communicates with the supplementary identification mark 5 that is secured to the carrier unit 4. If the reading device I receives the data of the fixedly assigned identification mark 5, operating ability of the reading device 1 may be assumed. The reading device 1 can write data to the fixedly assigned identification mark 5.

In one advantageous refinement, the fixedly assigned identification mark 5 has a lower reception sensitivity and/or transmission power than the identification mark 3. In this case, the reception sensitivity and/or transmission power can be reduced by means of a smaller antenna, a detuned antenna, an antenna with an attenuating resistance or by means of some other method that is familiar to the person skilled in the art. In order to test the monitoring system, it is particularly advantageous to reduce the reception sensitivity and/or transmission power of the fixedly assigned identification mark 5 to such an extent that it is just still possible to communicate with the reading device 1. If only a simple statement “reading device is functioning or is not functioning” has hitherto been possible, it is also possible, in this case, to additionally make qualitative statements about the communication channel. If, for example, a metal shield or a twisted reading device antenna results in a drop in the transmission power transmitted to the fixedly assigned identification mark 5, this transmission power is no longer sufficient to set up communication with the reading device 1. The reading device 1 then reports a defect. This makes it possible to identify faults in the communication channel, which faults could prevent reading devices 1 from correctly detecting objects with an identification mark 3.

In a further refinement, the identification mark 5 that is fixedly assigned to the reading device 1 is switched to the quiescent state after successfully communicating with the reading device 1. In this case, it is advantageous, when interrogating the identification marks 3, for the fixedly assigned identification mark 5 to no longer answer. Since only the responses of the identification marks 3 still have to be evaluated, the performance of the monitoring system is increased. The fixedly assigned identification mark 5 is automatically activated again in the event of a brief interruption in the power or by means of a special command of the reading device 1.

Since the reading device 1 communicates with the supplementary identification mark 5, there is a fixed assignment between the reading device 1 and the supplementary identification mark 5. If the data which is stored in the identification mark 5 and is transmitted to the reading device 1 contains location information, the location information is simultaneously coupled to the operating ability of the reading device 1. The location of the reading device 1 therefore no longer needs to be stored in the reading device 1 or a database 6 but rather can be taken from the supplementary identification mark 5. Mobile use of the reading device 1 is thus possible without manually inputting the location.

In addition to the location of the reading device, the supplementary identification mark 5 can also contain further information. This information can be stored in an individual supplementary identification mark 5 or in a plurality of supplementary identification marks 5. By way of example, the information may comprise the configuration of the reading device 1. Replacing defective reading devices 1 is considerably simplified as a result of the fact that the replacement reading device can fetch all of the information required for configuration such as, for example, the requisite transmission power from the identification mark 5 and can thus carry out automatic configuration. In this case, the configuration may also relate to the antenna secured to the reading device or to other components which are assigned to the reading device.

In a further embodiment, the state of the reading device 1 is stored in the identification mark 5. This makes it possible to record maintenance information and faults which have occurred, for example. It is also possible to record, on the supplementary identification mark 5, the number of articles with identification marks 3 that have been detected by the reading device 1. It is thus easily possible, when exchanging a reading device, to determine the correct configuration and function of the replacement reading device 1.

In addition to the location, configuration and state, it is also advantageous to store time information on the assigned identification mark 5. It is thus possible, for example, to record the time of the last fault-free read and write access of the reading device 1. This information can then be used, for example, to temporally delimit the cause of a fault in the monitoring system.

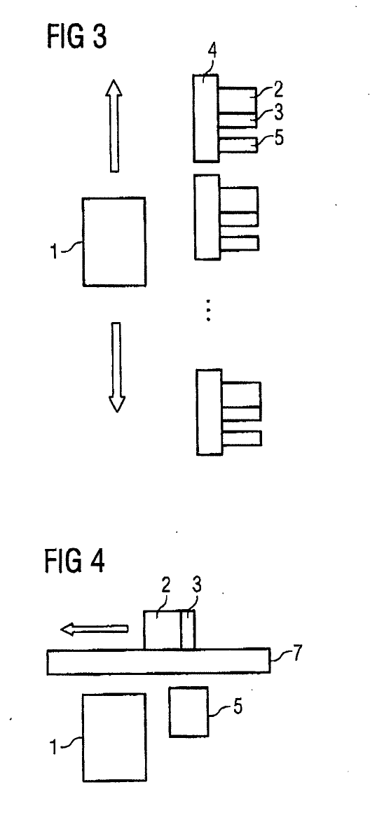

FIG. 3 shows an embodiment of the reading device 1, in which the reading device 1 is movable. In this case, the reading device 1 is guided along display racks 4 by means of rails, for example. In this case, the reading device 1 detects the articles 2 which are situated in the rack 4 by communicating with the identification marks 3 secured to the articles. Supplementary identification marks 5 are secured to the display racks 4. These supplementary identification marks 5 make it possible, with the aid of the method described in FIG. 2, to test the functionality of the reading device 1. If the information in the supplementary identification marks 5 contains location information, a location can additionally be assigned automatically to all of the articles 2. This dispenses with manually inputting (which would otherwise be necessary) the location of the articles 2 during mobile use of the reading device 1. Since the location information is contained in the supplementary identification marks 5, it is no longer necessary to fixedly install a reading device 1 at each place in the racks 4 at which articles 2 are situated. Only one mobile reading device 1 is needed to detect all of the articles 2.

FIG. 4 shows an embodiment of the reading device 1, in which the reading device 1 is fixedly installed and the articles 2 to be detected are moving. In this case, articles 2 can be situated on a conveyor belt 7, for example. If an article 2 moves past the reading device 1, the reading device 1 communicates with an identification mark 3 secured to the article 2 and thus detects the article 2. In order to check the functionality of the reading device 1, a supplementary identification mark 5 is again installed. In this case, the supplementary identification mark 5 is fitted in the vicinity of the reading device 1. If the reading device 1 can communicate with the supplementary identification mark 5, functionality of the reading device 1 can be assumed. The supplementary identification mark 5 can again contain information about the location, the configuration and the state of the reading device 1. If a reading device 1 fails, it can be replaced without complicated reconfiguration. For the purpose of simplifying the illustration, FIG. 4 illustrates only one reading device 1. However, it can easily be understood that a plurality of reading devices 1 are provided in a manner distributed along the conveyor belt. This is the case, for example, with a production line.

In summary, the exemplary embodiment described above can be characterized in that a reading device for detecting objects with identification marks is specified, it being possible to check the functionality of the reading device by fixedly assigning an identification mark. This identification mark can transmit a test signal that may contain information about the location, the configuration and the state of the reading device and the time of an interrogation.

A method for checking the functionality of reading devices for reading identification marks is also specified, in which method at least one identification mark is fixedly assigned to the reading device, the functionality being determined by the fact that it is possible to communicate with the fixedly assigned identification mark. In the method for checking the functionality of a reading device for reading identification marks, information about the location, the configuration and the state of the reading device and the time of an interrogation may be read out from the fixedly assigned identification mark.

While exemplary drawings and specific embodiments of the present invention have been described and illustrated, it is to be understood that the scope of the present invention is not to be limited to the particular embodiments discussed. Thus, the embodiments shall be regarded as illustrative rather than restrictive, and it should be understood that variations may be made in those embodiments by workers skilled in the art without departing from the scope of the present invention as set forth in the claims that follow, and equivalents thereof. In addition, the features of the different claims set forth below may be combined in various ways in further accordance with the present invention.

1. A reading device for detecting objects with identification marks, wherein at least one identification mark is fixedly assigned to the reading device.

2. The reading device as claimed in claim 1, wherein the at least one identification mark transmits a test signal that contains at least one item of location information.

3. The reading device as claimed in claim 2, wherein the at least one identification mark contains further information in addition to the location information.

4. The reading device as claimed in claim 1, wherein the at least one identification mark and the reading device communicate in a contactless manner.

5. The reading device as claimed in claim 1, wherein, in addition to the at least one identification mark that is fixedly assigned to the reading device, further identification marks which have identification information communicate with the reading device.

6. The reading device as claimed in claim 1, wherein the reading device is designed to be movable.

7. A method for checking the functionality of a reading device for reading identification marks, in which at least one identification mark is fixedly assigned to the reading device, comprising the step of: determining the functionality of the reading device by communicating, at least once, with the fixedly assigned identification mark.

8. A method for checking the functionality of a reading device for reading identification marks comprising the steps of: reading an item of information from a fixedly assigned identification mark, wherein the item of information is selected from the group consisting of location information, configuration information, state information, and time information.

9. The method as claimed in claim 8, wherein the item of information comprises location information.

10. The method as claimed in claim 8, wherein the item of information comprises configuration information.

11. The method as claimed in claim 8, wherein the item of information comprises state information.

12. The method as claimed in claim 8, wherein the item of information comprises time information.

13. The method as claimed in claim 8, in which the information that has been read out from the identification mark is used to configure the reading device.

14. A method for checking the functionality of a reading device for reading identification marks, in which at least one of reception sensitivity and transmission power of a fixedly assigned identification mark is lower than a reception sensitivity and transmission power of, respectively, of the other identification mark.

15. The method as claimed in claim 14, in which the at least one of the reception sensitivity and transmission power of the fixedly assigned identification mark is reduced to such an extent that it is just still possible to communicate with the reading device.

16. The method as claimed in claim 14, in which the at least one of the reception sensitivity and transmission power of the fixedly assigned identification mark is reduced by means of at least one of a smaller antenna, a detuned antenna, and an antenna with an attenuating resistance.

17. A method for checking the functionality of a reading device for reading identification marks comprising the step of switching one identification mark to a quiescent state after communication with it has taken place.

18. An arrangement for detecting objects comprising:
a reading device;
a plurality of identification marks with at least one of the marks being an identification mark that is fixedly assigned to the reading device, each of the identification marks being in communication with the reading device, wherein the functionality of the reading device is determined by the reading device communicating at least once with the fixedly assigned identification mark such that if the reading device receives data from the fixedly assigned identification mark, the operating ability of the reading device is assumed.

19. The arrangement as claimed in claim 18, wherein the reading device is movable.

20. The arrangement as claimed in claim 18, wherein the plurality of identification marks includes at least one first identification mark that is associated with and identifies the object to be detected, the fixedly assigned identification mark having at least one of a lower reception sensitivity and a transmission power compared to a reception sensitivity and transmission power, respectively, of the at least one first identification mark.

21. The arrangement as claimed in claim 18, wherein the fixedly assigned identification mark has data stored therein that contains location information and since the fixedly assigned identification mark communicated with the reading device, the location of the reading device is derived from the location information of the fixedly assigned identification mark.

22. The arrangement as claimed in claim 18, wherein the fixedly assigned identification mark stores at least one item of information selected from the group consisting of location information, configuration information, state information and time information, the at least one item of information being read by the reading device.

23. The arrangement as claimed in claim 20, wherein the fixedly assigned identification mark stores location information which is automatically assigned to all of the objects through by means of communication with the reading device and communication between the reading device and all of the first identification marks associated with the objects.
